(19) United States
(12) Patent Application Publication
(10) Pub. No.: US 2015/0219939 A1
(43) Pub. Date: Aug. 6, 2015

(54) METHOD OF DRIVING A LIGHT SOURCE, LIGHT SOURCE DRIVING APPARATUS FOR PERFORMING THE METHOD AND DISPLAY APPARATUS HAVING THE LIGHT SOURCE DRIVING APPARATUS

(71) Applicant: Samsung Display Co., LTD., Yongin-City (KR)

(72) Inventors: Kuk-Hwan AHN, Hwaseong-si (KR); Jai-Hyun KOH, Hwaseong-si (KR); Dong-Won PARK, Hwaseong-si (KR)

(21) Appl. No.: 14/325,697

(22) Filed: Jul. 8, 2014

(30) Foreign Application Priority Data
Feb. 5, 2014 (KR) 10-2014-0013124

(51) Int. Cl. G02F 1/1335; G09G 3/34; H05B 37/02

(52) U.S. Cl. CPC G02F 1/1336; H05B 37/0209; H05B 37/0281; G09G 3/3426; G09G 2320/0233

(57) ABSTRACT

A method of driving a light source includes outputting a light source control signal controlling a plurality of light sources, and outputting a plurality of light source driving signals to the light sources, respectively, based on the light source control signal, wherein the light source driving signals have different bit values.

This application claims priority to Korean Patent Application No. 10-2014-0013124, filed on Feb. 5, 2014, and all the benefits accruing therefrom under 35 U.S.C. §119, the content of which in its entirety is herein incorporated by reference.

### BACKGROUND

1. Field

Exemplary embodiments of the invention relate to a method of driving a light source, a light source driving apparatus for performing the method and a display apparatus including the light source driving apparatus. More particularly, exemplary embodiments of the invention relate to a method of driving a light source in a display apparatus, a light source driving apparatus for performing the method and a display apparatus including the light source driving apparatus.

2. Description of the Related Art

A liquid crystal display apparatus typically includes a liquid crystal display panel, a gate driving part, a data driving part and a timing controlling part. Such a liquid crystal display apparatus is a non-emitting apparatus, therefore the liquid crystal display apparatus further include a light source part for providing light to the liquid crystal display panel.

A luminance of the light is controlled based on a data signal provided to the liquid crystal display panel based on an image data provided from the timing controlling part to the data driving part.

However, when the luminance of the light generated from the light source part is not precisely controlled, display quality of the liquid crystal display apparatus is decreased.

### SUMMARY

Exemplary embodiments of the invention provide a method of driving a light source capable of improving display quality.

Exemplary embodiments of the invention also provide a light source driving apparatus for performing the above-mentioned method.

Exemplary embodiments of the invention also provide a display apparatus having the above-mentioned light source driving apparatus.

According to an exemplary embodiment of the invention, a method of driving a light source includes outputting a light source control signal which controls a plurality of light sources, and outputting a plurality of light source driving signals to the light sources, respectively, based on the light source control signal, where the light source driving signals have different bit values.

In an exemplary embodiment, the light source driving signals having the different bit values may have a first bit average value during a first time period, and the light source driving signals may have a second bit average value different from the first bit average value during a second time period different from the first time period.

In an exemplary embodiment, the light sources may include first to fourth light sources, the light source driving signals may include first to fourth light source driving signals which drive the first to fourth light sources, respectively, and the first to fourth light source driving signals may have the different bit values during the first time period.

In an exemplary embodiment, a difference between the different bit values may be 1.

In an exemplary embodiment, a minimum difference between the first bit average value and the second bit average value may be 0.25.

In an exemplary embodiment, the light sources may include first to eighth light sources, the light source driving signals may include first to eighth light source driving signals which drive the first to eighth light sources, respectively, and the first to eighth light source driving signals may have the different bit values during the first time period.

In an exemplary embodiment, a difference between the different bit values may be 1.

In an exemplary embodiment, a minimum difference between the first bit average value and the second bit average value may be 0.125.

In an exemplary embodiment, the light sources may include first and second light sources, the light source driving signals may include first and second light source driving signals which drive the first and second light sources, respectively, and the first and second light source driving signals may have the different bit values during the first time period.

In an exemplary embodiment, a difference between the different bit values may be 1.

In an exemplary embodiment, a minimum difference between the first bit average value and the second bit average value may be 0.5.

In an exemplary embodiment, the number of the light sources may be N which is a natural number, a difference of the different bit values may be 1, and a minimum difference between the first bit average value and the second bit average value may be 1/N.

According to an exemplary embodiment of the invention, a light source driving apparatus includes a timing controlling part configured to output a light source control signal which controls a plurality of light sources, and a light source driving part configured to output a plurality of light source driving signals to the light sources, respectively, based on the light source control signal, where the light source driving signals have different bit values.

In an exemplary embodiment, the light source driving signals having the different bit values may have a first bit average value during a first time period, and the light source driving signals may have a second bit average value different from the first bit average value during a second time period different from the first time period.

In an exemplary embodiment, the light sources may include first to fourth light sources, the light source driving signals may include first to fourth light source driving signals which drive the first to fourth light sources, respectively, the first to fourth light source driving signals may have the different bit values during the first time period, a difference between the different bit values may be 1, and a minimum difference between the first bit average value and the second bit average value may be 0.25.

In an exemplary embodiment, the light sources may include first to eighth light sources, the light source driving signals may include first to eighth light source driving signals which drive the first to eighth light sources, respectively, the first to eighth light source driving signals may have the different bit values during the first time period, a difference between the different bit values may be 1, and a minimum difference between the first bit average value and the second bit average value may be 0.125.

In an exemplary embodiment, the light sources may include first and second light sources, the light source driving signals may include first and second light source driving signals which drive the first and second light sources, respectively, the first and second light source driving signals may have the different bit values during the first time period, a difference between the different bit values may be 1, and a minimum difference between the first bit average value and the second bit average value may be 0.5.

In an exemplary embodiment, the number of the light sources may be N which is a natural number, a difference between the different bit values may be 1, and a minimum difference between the first bit average value and the second bit average value may be 1/N.

According to an exemplary embodiment of the invention, a display apparatus includes a display panel, a gate driving part, a data driving part, a light source part and a light source driving apparatus. In such an embodiment, the display panel includes a gate line and a data line, and is configured to display an image. In such an embodiment, the gate driving part is configured to output a gate signal to the gate line, the data driving part is configured to output a data signal to the data line, and the light source part is configured to provide light to the display panel and includes a plurality of light sources. In such an embodiment, the light source driving apparatus includes a timing controlling part configured to output a gate control signal which controls the gate driving part, a data control signal which controls the data driving part and a light source control signal which controls the light sources, and a light source driving part configured output a plurality of light source driving signals to the light sources, respectively, based on the light source control signal, where the light source driving signals have different bit values.

In an exemplary embodiment, the light source driving signals having the different bit values may have a first bit average value during a first time period, and the light source driving signals may have a second bit average value different from the first bit average value during a second time period different from the first time period.

According to exemplary embodiments of the invention, light provided from a light source part to a display panel may be minutely controlled. Thus, display quality of the display apparatus may be improved.

### BRIEF DESCRIPTION OF THE DRAWINGS

The above and other features the invention will become more apparent by describing in detailed example embodiments thereof with reference to the accompanying drawings, in which:

FIG. 1 is a block diagram illustrating an exemplary embodiment of a display apparatus according to the invention;

FIGS. 2A and 2B are flow charts illustrating an exemplary embodiment of a method of driving a light source performed by a light source driving apparatus of FIG. 1;

FIG. 3 is a block diagram illustrating an alternative exemplary embodiment of a display apparatus according to the invention;

FIGS. 4A and 4B are flow charts illustrating an exemplary embodiment of a method of driving a light source performed by a light source driving apparatus of FIG. 3;

FIG. 5 is a block diagram illustrating another alternative exemplary embodiment of a display apparatus according to the invention; and

FIGS. 6A and 6B are flow charts illustrating an exemplary embodiment of a method of driving a light source performed by a light source driving apparatus of FIG. 5.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

Hereinafter, exemplary embodiments of the invention will be described in detail with reference to the accompanying drawings.

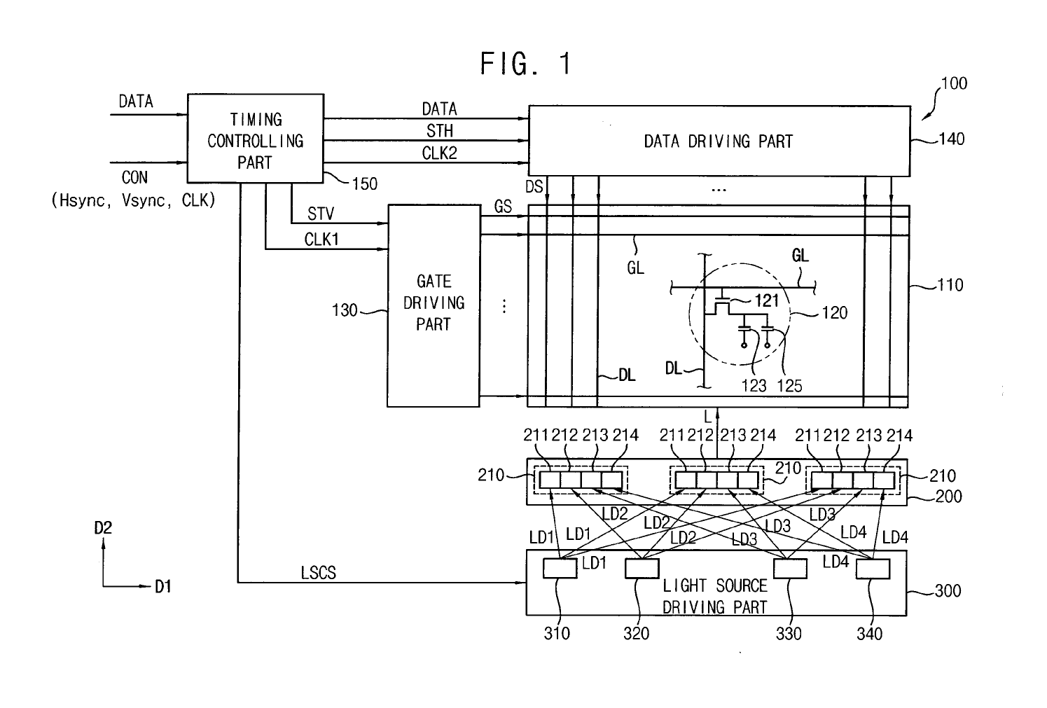

FIG. 1 is a block diagram illustrating an exemplary embodiment of a display apparatus according to the invention.

Referring to FIG. 1, an exemplary embodiment of the display apparatus 100 according to the invention includes a display panel 110, a gate driving part 130, a data driving part 140, a timing controlling part 150, a light source part 200 and a light source driving part 300. The timing controlling part 150 and the light source driving part 300 may be define a light source driving apparatus that drives the light source part 200.

The display panel 110 receives a data signal DS based on an image data DATA provided from the timing controlling part 150 to display an image. In one exemplary embodiment, for example, the image data DATA may be two-dimensional plane image data. Alternatively, the image data DATA may include a left-eye image data and a right-eye image data for displaying a three-dimensional stereoscopic image.

The display panel 110 includes gate lines GL, data lines DL and a plurality of pixels 120. The gate lines extend substantially in a first direction D1, and the data lines extend substantially in a second direction D2 that is perpendicular to the first direction D1. Each of the pixels 120 includes a thin film transistor 121 electrically connected to a gate line GL and a data line DL, a liquid crystal capacitor 123 and a storage capacitor 125 connected to the thin film transistor 121.

The gate driving part 130 generates gate signal GS in response to a gate start signal STV and a gate clock signal CLK1 provided from the timing controlling part 150, and outputs gate signal GS to the gate line

The data driving part 140 outputs the data signals DS to the data line DL in response to a data start signal STH and a data clock signal CLK2 provided from the timing controlling part 150.

The timing controlling part 150 receives the image data DATA and a control signal CON from an outside, e.g., from an external device. The control signal CON may include a horizontal synchronous signal Hsync, a vertical synchronous signal Vsync and a clock signal CLK. In an exemplary embodiment, the timing controlling part 150 generates the data start signal STH based on, e.g., using, the horizontal synchronous signal Hsync and outputs the data start signal STH to the data driving part 140. In such an embodiment, the timing controlling part 150 generates the gate start signal STV based on the vertical synchronous signal Vsync and outputs the gate start signal STV to the gate driving part 130. In such an embodiment, the timing controlling part 150 generates the gate clock signal CLK1 and the data clock signal CLK2 based on the clock signal CLK, outputs the gate clock signal CLK1 to the gate driving part 130, and outputs the data clock signal CLK2 to the data driving part 140. The timing controlling part 150 may further output a light source control signal LSCS that controls a first light source 211, a second light source 212, a third light source 213 and a fourth light source 214, which are included in the light source part 200, to the light source driving part 300.

The light source part 200 provides light L to the display panel 110. The light source part 200 includes a light source group 210, and the light source group 210 may include the first light source 211, the second light source 212, the third light source 213 and the fourth light source 214.

The light source driving part 300 drives the first light source 211, the second light source 212, the third light source 213 and the fourth light source 214 of the light source part 200 based on the light source control signal LSCS provided from the timing controlling part 150.

In an exemplary embodiment, the light source driving part 300 includes a first light source driver 310, a second light source driver 320, a third light source driver 330 and a fourth light source driver 340. The first light source driver 310 outputs a first light source driving signal LD1 that drives the first light source 211 to the first light source 211. The second light source driver 320 outputs a second light source driving signal LD2 that drives the second light source 212 to the second light source 213. The third light source driver 330 outputs a third light source driving signal LD3 that drives the third light source 213 to the third light source 213. The fourth light source driver 340 outputs a fourth light source driving signal LD4 that drives the fourth light source 214 to the fourth light source 214.

Each of the first light source driving signal LD1, the second light source driving signal LD2, the third light source driving signal LD3 and the fourth light source driving signal LD4 includes n bit information or data. In one exemplary embodiment, for example, each of the first light source driving signal LD1, the second light source driving signal LD2, the third light source driving signal LD3 and the fourth light source driving signal LD4 includes 8 bit information or data. Each of the first light source driving signal LD1, the second light source driving signal LD2, the third light source driving signal LD3 and the fourth light source driving signal LD4 may be a pulse width modulation signal.

In an exemplary embodiment, the first light source driving signal LD1, the second light source driving signal LD2, the third light source driving signal LD3 and the fourth light source driving signal LD4 have different bit values. In such an embodiment, the first light source driving signal LD1, the second light source driving signal LD2, the third light source driving signal LD3 and the fourth light source driving signal LD4 have the different bit values and have a first bit average value during a first time period, and the first light source driving signal LD1, the second light source driving signal LD2, the third light source driving signal LD3 and the fourth light source driving signal LD4 have a second bit average value different from the first bit average value during a second time period different from the first time period. In such an embodiment, a difference of the bit values of the first light source driving signal LD1, the second light source driving signal LD2, the third light source driving signal LD3 and the fourth light source driving signal LD4 is one (1).

In one exemplary embodiment, for example, the bit values of the first light source driving signal LD1, the second light source driving signal LD2, the third light source driving signal LD3 and the fourth light source driving signal LD4 may be as in the following Table 1.

TABLE 1

| | N − 2 | N − 1 | N | N + 1 |
|---|---|---|---|---|
| LD1 | 255 | 254 | 254 | 255 |
| LD2 | 254 | 255 | 255 | 255 |
| LD3 | 254 | 255 | 255 | 255 |
| LD4 | 254 | 254 | 255 | 255 |
| Bit average value | 254.25 | 254.5 | 254.75 | 255 |

In an exemplary embodiment, as shown in the Table 1 above, the bit values of the first to fourth light source driving signals LD1, LD2, LD3 and LD4 may be 255, 254, 254 and 254, respectively, during an (N−2)-th time period. In such an embodiment, the bit average value of the first to fourth light source driving signals LD1, LD2, LD3 and LD4 during the (N−2)-th time period is 254.25. In an exemplary embodiment, the bit values of the first to fourth light source driving signals LD1, LD2, LD3 and LD4 may be 254, 255, 255 and 254, respectively, during an (N−1)-th time period. In such an embodiment, the bit average value of the first to fourth light source driving signals LD1, LD2, LD3 and LD4 during the (N−1)-th time period is 254.5. In an exemplary embodiment, the bit values of the first to fourth light source driving signals LD1, LD2, LD3 and LD4 may be 254, 255, 255 and 255, respectively, during an N-th time period. In such an embodiment, the bit average value of the first to fourth light source driving signals LD1, LD2, LD3 and LD4 during the N-th time period is 254.75. In an exemplary embodiment, the bit values of the first to fourth light source driving signals LD1, LD2, LD3 and LD4 may be 255, 255, 255 and 255, respectively, during an (N+1)-th time period. In such an embodiment, the bit average value of the first to fourth light source driving signals LD1, LD2, LD3 and LD4 during the (N+1)-th time period is 255.

The (N−2)-th time period may be a first time period, and the (N−1)-th time period may be a second time period. In an exemplary embodiment, the first bit average value is 254.25, the second bit average value is 254.5, and a difference between the first bit average value and the second bit average value is 0.25.

When the bit values of the first to fourth light source driving signals LD1, LD2, LD3 and LD4 are substantially the same as each other, a bit average value of the first to fourth light source driving signals LD1, LD2, LD3 and LD4 during the (N−2)-th to (N+1)-th time periods is changed with a minimum difference of 1. However, in an exemplary embodiment of the invention, the bit average value of the first to fourth light source driving signals LD1, LD2, LD3 and LD4 during the (N−2)-th to (N+1)-th time periods is changed with a minimum difference of 0.25. Thus, in such an embodiment, a luminance of the light L generated from the light source part 200 may be effectively, e.g., minutely, controlled.

In an exemplary embodiment, the light source part 200 includes the first to fourth light sources 211, 212, 213 and 214, but it is not limited thereto. In one exemplary embodiment, for example, the light source part 200 may include N (N is a natural number) light sources, and the light source driving part 300 may include N light source drivers that output N light source driving signals to the N light sources to drive the N light sources. In such an embodiment, the difference between the first bit average value and the second bit average value may be 1/N, and a bit average value may be changed with a minimum difference of 1/N.

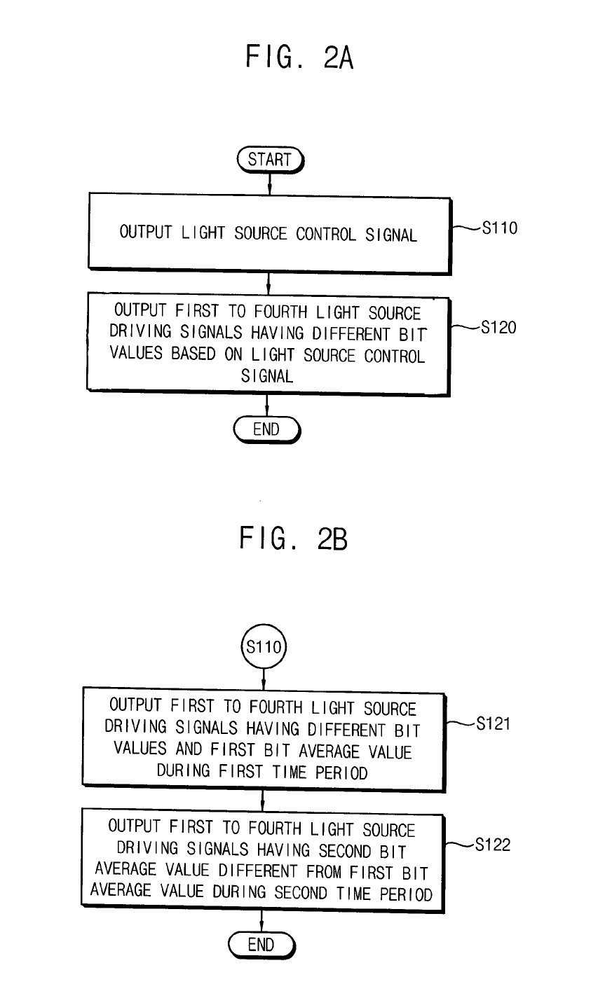

FIGS. 2A and 2B are flow charts illustrating an exemplary embodiment of a method of driving a light source performed by the light source driving apparatus of FIG. 1.

Referring to FIGS. 1 to 2B, the light source control signal LSCS is outputted (S110). In an exemplary embodiment, the timing controlling part 150 outputs the light source control signal LSCS driving the first light source 211, the second light source 212, the third light source 213 and the fourth light source 214 included in the light source part 200 to the light source driving part 300.

The first to fourth light source driving signals LD1, LD2, LD3 and LD4 having the different bit values are outputted based on the light source control signal LSCS (S120).

In an exemplary embodiment, the first to fourth light source driving signals LD1, LD2, LD3 and LD4 having the different bit values and having the first bit average value are outputted during the first time period (S121). The light source driving part 300 includes the first light source driver 310, the second light source driver 320, the third light source driver 330 and the fourth light source driver 340. The first light source driver 310 outputs the first light source driving signal LD1 driving the first light source 211 to the first light source 211. The second light source driver 320 outputs the second light source driving signal LD2 driving the second light source 212 to the second light source 212. The third light source driver 330 outputs the third light source driving signal LD3 driving the third light source 213 to the third light source 213. The fourth light source driver 340 outputs the fourth light source driving signal LD4 driving the fourth light source 214 to the fourth light source 214. In one exemplary embodiment, for example, the bit values of the first to fourth light source driving signals LD1, LD2, LD3 and LD4 during the (N−2)-th time period may be 255, 254, 254 and 254, respectively. In such an embodiment, the bit average value of the first to fourth light source driving signals LD1, LD2, LD3 and LD4 is 254.25.

The first to fourth light source driving signals LD1, LD2, LD3 and LD4 having the second bit average value different from the first bit average value are outputted during the second time period (S122). In one exemplary embodiment, for example, the bit values of the first to fourth light source driving signals LD1, LD2, LD3 and LD4 may be 254, 255, 255 and 254, respectively, during the (N−1)-th time period. In such an embodiment, the bit average value of the first to fourth light source driving signals LD1, LD2, LD3 and LD4 is 254.5.

According to an exemplary embodiment, the bit average value of the first to fourth light source driving signals LD1, LD2, LD3 and LD4 is changed with a minimum difference of 0.25. Thus, the luminance of the light L generated from the light source part 200 may be effectively controlled.

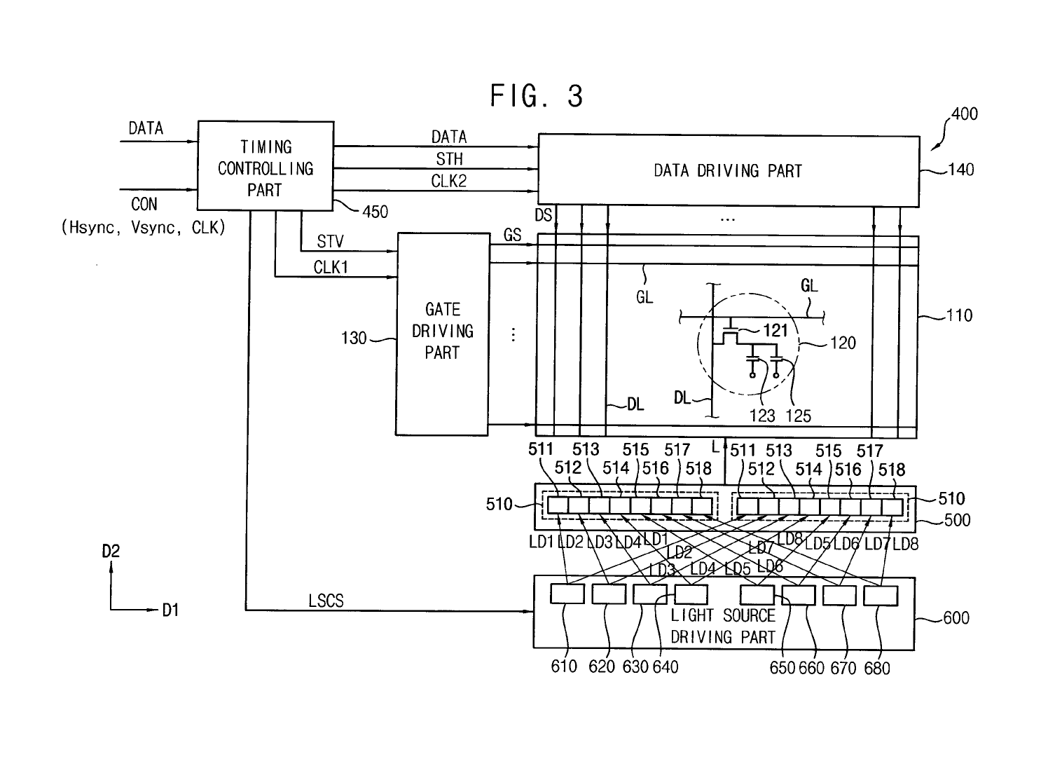

FIG. 3 is a block diagram illustrating an alternative exemplary embodiment of a display apparatus according to the invention.

The display apparatus 400 shown in FIG. 3 is substantially the same as the display apparatus 100 illustrated in FIG. 1 except for a timing controlling part 450, the light source part 500 and a light source driving part 600. The same or like elements shown in FIG. 3 have been labeled with the same reference characters as used above to describe the exemplary embodiments of the display apparatus 100 shown in FIG. 1, and any repetitive detailed description thereof will hereinafter be omitted or simplified.

Referring to FIG. 3, an exemplary embodiment of the display apparatus 400 includes the display panel 110, the gate driving part 130, the data driving part 140, the timing controlling part 450, the light source part 500 and the light source driving part 600. The timing controlling part 450 and the light source driving part 600 may define a light source driving apparatus that drives the light source part 500.

The timing controlling part 450 receives the image data DATA and the control signal CON from the outside. The control signal CON may include the horizontal synchronous signal Hsync, the vertical synchronous signal Vsync and the clock signal CLK. The timing controlling part 450 generates the data start signal STH based on the horizontal synchronous signal Hsync and outputs the data start signal STH to the data driving part 140. In addition, the timing controlling part 450 generates the gate start signal STV based on the vertical synchronous signal Vsync and outputs the gate start signal STV to the gate driving part 130. In addition, the timing controlling part 450 generates the gate clock signal CLK1 and the data clock signal CLK2 based on the clock signal CLK, outputs the gate clock signal CLK1 to the gate driving part 130, and outputs the data clock signal CLK2 to the data driving part 140. In an exemplary embodiment, the timing controlling part 450 may further output a light source control signal LSCS that controls a first light source 511, a second light source 512, a third light source 513, a fourth light source 514, a fifth light source 515, a sixth light source 516, a seventh light source 517 and an eighth light source 518, which are included in the light source part 500, to the light source driving part 600.

The light source part 500 provides light L to the display panel 110. The light source part 500 includes a light source group 510, and the light source group 510 includes the first light source 511, the second light source 512, the third light source 513, the fourth light source 514, the fifth light source 515, the sixth light source 516, the seventh light source 517 and the eighth light source 518.

The light source driving part 600 drives the first light source 511, the second light source 512, the third light source 513, the fourth light source 514, the fifth light source 515, the sixth light source 516, the seventh light source 517 and the eighth light source 518 of the light source part 500 based on the light source control signal LSCS provided from the timing controlling part 450.

In an exemplary embodiment, the light source driving part 600 includes a first light source driver 610, a second light source driver 620, a third light source driver 630, a fourth light source driver 640, a fifth light source driver 650, a sixth light source driver 660, a seventh light source driver 670 and an eighth light source driver 680. The first light source driver 610 outputs a first light source driving signal LD1 that drives the first light source 511 to the first light source 511. The second light source driver 620 outputs a second light source driving signal LD2 that drives the second light source 512 to the second light source 512. The third light source driver 630 outputs a third light source driving signal LD3 that drives the third light source 513 to the third light source 513. The fourth light source driver 640 outputs a fourth light source driving signal LD4 that drives the fourth light source 514 to the fourth light source 514. The fifth light source driver 650 outputs a fifth light source driving signal LD5 that drives the fifth light source 515 to the fifth light source 515. The sixth light source driver 660 outputs a sixth light source driving signal LD6 that drives the sixth light source 516 to the sixth light source 516. The seventh light source driver 670 outputs a seventh light source driving signal LD7 that drives the seventh light source 517 to the seventh light source 517. The eighth light source driver 680 outputs an eighth light source driving signal LD8 that drives the eighth light source 518 to the eighth light source 518.

Each of the first light source driving signal LD1, the second light source driving signal LD2, the third light source driving signal LD3, the fourth light source driving signal LD4, the fifth light source driving signal LD5, the sixth light source driving signal LD6, the seventh light source driving signal LD7 and the eighth light source driving signal LD8 includes n bit information or data. In one exemplary embodiment, for example, each of the first light source driving signal LD1, the second light source driving signal LD2, the third light source driving signal LD3, the fourth light source driving signal LD4, the fifth light source driving signal LD5, the sixth light source driving signal LD6, the seventh light source driving signal LD7 and the eighth light source driving signal LD8 may include 8 bit information or data. Each of the first light source driving signal LD1, the second light source driving signal LD2, the third light source driving signal LD3, the fourth light source driving signal LD4, the fifth light source driving signal LD5, the sixth light source driving signal LD6, the seventh light source driving signal LD7 and the eighth light source driving signal LD8 may be a pulse width modulation signal.

In an exemplary embodiment, the first light source driving signal LD1, the second light source driving signal LD2, the third light source driving signal LD3, the fourth light source driving signal LD4, the fifth light source driving signal LD5, the sixth light source driving signal LD6, the seventh light source driving signal LD7 and the eighth light source driving signal LD8 have different bit values. In such an embodiment, the first light source driving signal LD1, the second light source driving signal LD2, the third light source driving signal LD3, the fourth light source driving signal LD4, the fifth light source driving signal LD5, the sixth light source driving signal LD6, the seventh light source driving signal LD7 and the eighth light source driving signal LD8 have the different bit values and have a first bit average value during a first time period, and the first light source driving signal LD1, the second light source driving signal LD2, the third light source driving signal LD3, the fourth light source driving signal LD4, the fifth light source driving signal LD5, the sixth light source driving signal LD6, the seventh light source driving signal LD7 and the eighth light source driving signal LD8 have a second bit average value different from the first bit average value during a second time period different from the first time period. In such an embodiment, a difference of the bit values of the first light source driving signal LD1, the second light source driving signal LD2, the third light source driving signal LD3, the fourth light source driving signal LD4, the fifth light source driving signal LD5, the sixth light source driving signal LD6, the seventh light source driving signal LD7 and the eighth light source driving signal LD8 is one (1).

In one exemplary embodiment, for example, the bit values of the first light source driving signal LD1, the second light source driving signal LD2, the third light source driving signal LD3, the fourth light source driving signal LD4, the fifth light source driving signal LD5, the sixth light source driving signal LD6, the seventh light source driving signal LD7 and the eighth light source driving signal LD8 may be as in the following Table 2.

TABLE 2

| | N − 2 | N − 1 | N | N + 1 | N + 2 | N + 3 | N + 4 | N + 5 |
|---|---|---|---|---|---|---|---|---|
| LD1 | 255 | 254 | 254 | 255 | 254 | 254 | 254 | 255 |
| LD2 | 254 | 255 | 254 | 254 | 254 | 255 | 255 | 255 |
| LD3 | 254 | 254 | 254 | 255 | 254 | 255 | 255 | 255 |
| LD4 | 254 | 254 | 254 | 254 | 255 | 255 | 255 | 255 |
| LD5 | 254 | 254 | 254 | 255 | 255 | 255 | 255 | 255 |
| LD6 | 254 | 254 | 255 | 254 | 255 | 255 | 255 | 255 |
| LD7 | 254 | 255 | 255 | 255 | 255 | 255 | 255 | 255 |
| LD8 | 254 | 254 | 255 | 254 | 255 | 254 | 255 | 255 |
| Bit average value | 254.125 | 254.25 | 254.375 | 254.5 | 254.625 | 254.75 | 254.875 | 255 |

In an exemplary embodiment, as shown in the Table 2, the bit values of the first to eighth light source driving signals LD1, LD2, LD3, LD4, LD5, LD6, LD7 and LD8 may be 255, 254, 254, 254, 254, 254, 254 and 254, respectively, during an (N−2)-th time period. In such an embodiment, the bit average value of the first to eighth light source driving signals LD1, LD2, LD3, LD4, LD5, LD6, LD7 and LD8 during the (N−2)-th time period is 254.125. In an exemplary embodiment, the bit values of the first to eighth light source driving signals LD1, LD2, LD3, LD4, LD5, LD6, LD7 and LD8 may be 254, 255, 254, 254, 254, 254, 255 and 254, respectively, during an (N−1)-th time period. In such an embodiment, the bit average value of the first to eighth light source driving signals LD1, LD2, LD3, LD4, LD5, LD6, LD7 and LD8 the (N−1)-th time period is 254.25. In an exemplary embodiment, the bit values of the first to eighth light source driving signals LD1, LD2, LD3, LD4, LD5, LD6, LD7 and LD8 may be 254, 254, 254, 254, 254, 255, 255 and 255, respectively, during an N-th time period. In such an embodiment, the bit average value of the first to eighth light source driving signals LD1, LD2, LD3, LD4, LD5, LD6, LD7 and LD8 during the N-th time period is 254.375. In an exemplary embodiment, the bit values of the first to eighth light source driving signals LD1, LD2, LD3, LD4, LD5, LD6, LD7 and LD8 may be 255, 254, 255, 254, 255, 254, 255 and 254, respectively, during an (N+1)-th time period. In such an embodiment, the bit average value of the first to eighth light source driving signals LD1, LD2, LD3, LD4, LD5, LD6, LD7 and LD8 during the (N+1)-th time period is 254.5. In an exemplary embodiment, the bit values of the first to eighth light source driving signals LD1, LD2, LD3, LD4, LD5, LD6, LD7 and LD8 may be 254, 254, 254, 255, 255, 255, 255 and 255, respectively, during an (N+2)-th time period. In such an embodiment, the bit average value of the first to eighth light source driving signals LD1, LD2, LD3, LD4, LD5, LD6, LD7 and LD8 during the (N+2)-th time period is 254.625. In an exemplary embodiment, the bit values of the first to eighth light source driving signals LD1, LD2, LD3, LD4, LD5, LD6, LD7 and LD8 may be 254, 255, 255, 255, 255, 255, 255 and 254, respectively, during an (N+3)-th time period. In such an embodiment, the bit average value of the first to eighth light source driving signals LD1, LD2, LD3, LD4, LD5, LD6, LD7 and LD8 during the (N+3)-th time period is 254.75. In an exemplary embodiment, the bit values of the first to eighth light source driving signals LD1, LD2, LD3, LD4, LD5, LD6, LD7 and LD8 may be 254, 255, 255, 255, 255, 255, 255 and 255, respectively, during an (N+4)-th time period. In such an embodiment, the bit average value of the first to eighth light source driving signals LD1, LD2, LD3, LD4, LD5, LD6, LD7 and LD8 during the (N+4)-th time period is 254.875. In an exemplary embodiment, the bit values of the first to eighth light source driving signals LD1, LD2, LD3, LD4, LD5, LD6, LD7 and LD8 may be 255, 255, 255, 255, 255, 255, 255 and 255, respectively, during an (N+5)-th time period. In such an embodiment, the bit average value of the first to eighth light source driving signals LD1, LD2, LD3, LD4, LD5, LD6, LD7 and LD8 during the (N+5)-th time period is 255.

The (N−2)-th time period may be a first time period, and the (N−1)-th time period may be a second time period. In an exemplary embodiment, the first bit average value is 254.125, the second bit average value is 254.25, and a difference between the first bit average value and the second bit average value is 0.125.

When the bit values of the first to eighth light source driving signals LD1, LD2, LD3, LD4, LD5, LD6, LD7 and LD8 are substantially the same as each other, a bit average value of the first to eighth light source driving signals LD1, LD2, LD3, LD4, LD5, LD6, LD7 and LD8 during the (N−2)-th to (N+5)-th time periods is changed with a minimum difference of 1. However, in an exemplary embodiment, the bit average value of the first to eighth light source driving signals LD1, LD2, LD3, LD4, LD5, LD6, LD7 and LD8 during the (N−2)-th to (N+5)-th time periods is changed with a minimum difference of 0.125. Thus, a luminance of the light L generated from the light source part 500 may be effectively controlled.

In an exemplary embodiment, the light source part 500 includes the first to eighth light sources 511, 512, 513, 514, 515, 516, 517 and 518, but it is not limited thereto. In one exemplary embodiment, for example, the light source part 500 may include N (N is a natural number) light sources, and the light source driving part 600 may include N light source drivers that output N light source driving signals to the N light sources to drive the N light sources. In such an embodiment, the difference between the first bit average value and the second bit average value may be 1/N, and a bit average value may be changed with a minimum difference of 1/N.

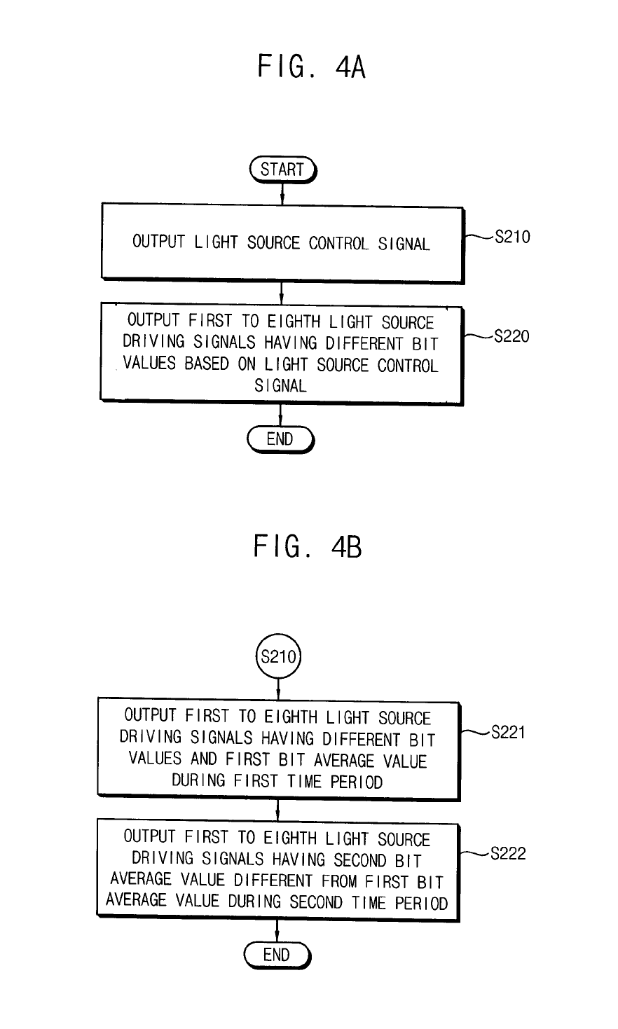

FIGS. 4A and 4B are flow charts illustrating an exemplary embodiment of a method of driving a light source performed by the light source driving apparatus of FIG. 3.

Referring to FIGS. 1 to 4B, the light source control signal LSCS is outputted (S210). In an exemplary embodiment, the timing controlling part 450 outputs the light source control signal LSCS driving the first light source 511, the second light source 512, the third light source 513, the fourth light source 514, the fifth light source 515, the sixth light source 516, the seventh light source 517 and the eighth light source 518 included in the light source part 500 to the light source driving part 600.

The first to eighth light source driving signals LD1, LD2, LD3, LD4, LD5, LD6, LD7 and LD8 having the different bit values are outputted based on the light source control signal LSCS (S220).

In an exemplary embodiment, the first to eighth light source driving signals LD1, LD2, LD3, LD4, LD5, LD6, LD7 and LD8 having the different bit values and having the first bit average value are outputted during the first time period (S221). The light source driving part 600 includes the first light source driver 610, the second light source driver 620, the third light source driver 630, the fourth light source driver 640, the fifth light source driver 650, the sixth light source driving part 660, the seventh light source driver 670 and the eighth light source driver 680. The first light source driver 610 outputs the first light source driving signal LD1 that drives the first light source 511 to the first light source 511. The second light source driver 620 outputs the second light source driving signal LD2 that drives the second light source 512 to the second light source 512. The third light source driver 630 outputs the third light source driving signal LD3 that drives the third light source 513 to the third light source 513. The fourth light source driver 640 outputs the fourth light source driving signal LD4 that drives the fourth light source 514 to the fourth light source 514. The fifth light source driver 650 outputs the fifth light source driving signal LD5 that drives the fifth light source 515 to the fifth light source 515. The sixth light source driver 660 outputs the sixth light source driving signal LD6 that drives the sixth light source 516 to the sixth light source 516. The seventh light source driver 670 outputs the seventh light source driving signal LD7 that drives the seventh light source 517 to the seventh light source 517. The eighth light source driver 680 outputs the eighth light source driving signal LD8 that drives the eighth light source 518 to the eighth light source 518. In one exemplary embodiment, for example, the bit values of the first to eighth light source driving signals LD1, LD2, LD3, LD4, LD5, LD6, LD7 and LD8 may be 255, 254, 254, 254, 254, 254, 254 and 254 respectively during the (N−2)-th time period. In such an embodiment, the bit average value of the first to eighth light source driving signals LD1, LD2, LD3, LD4, LD5, LD6, LD7 and LD8 is 254.125.

The first to eighth light source driving signals LD1, LD2, LD3, LD4, LD5, LD6, LD7 and LD8 having the second bit average value different from the first bit average value are outputted during the second time period (S222). In one exemplary embodiment, for example, the bit values of the first to eighth light source driving signals LD1, LD2, LD3, LD4, LD5, LD6, LD7 and LD8 may be 254, 255, 254, 254, 254, 254, 255 and 254 respectively during the (N−1)-th time period. In such an embodiment, the bit average value of the first to eighth light source driving signals LD1, LD2, LD3, LD4, LD5, LD6, LD7 and LD8 is 254.25.

According to an exemplary embodiment, the bit average value of the first to eighth light source driving signals LD1, LD2, LD3, LD4, LD5, LD6, LD7 and LD8 is changed with a minimum difference of 0.125. Thus, the luminance of the light L generated from the light source part 500 may be effectively controlled.

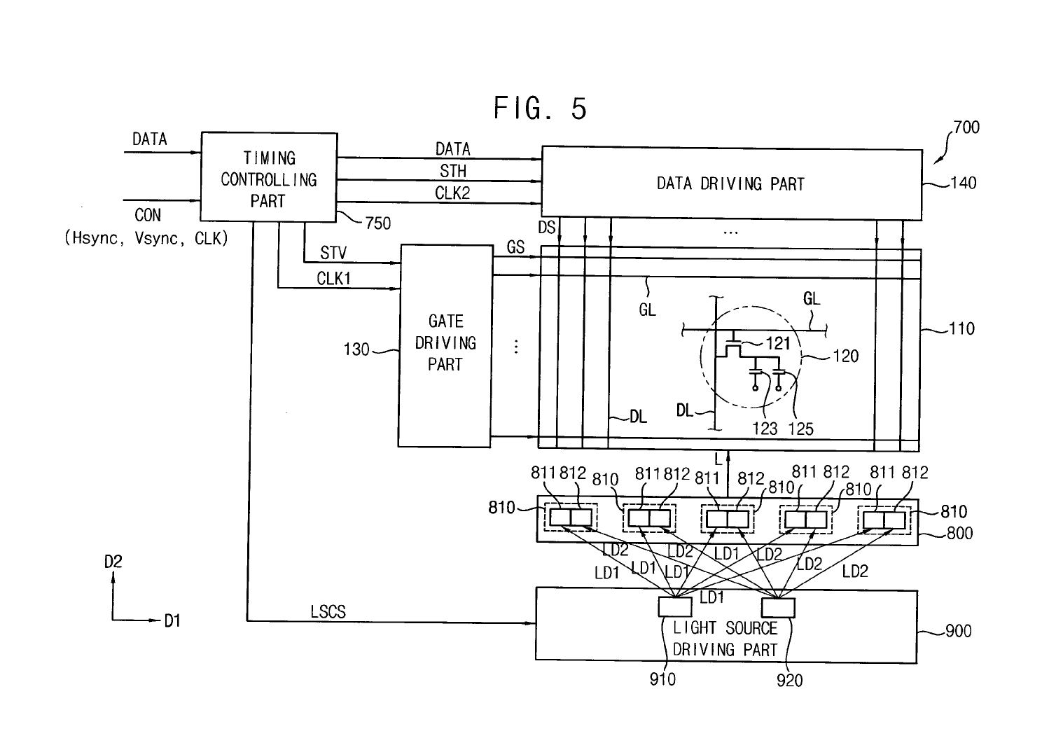

FIG. 5 is a block diagram illustrating a display apparatus according to an exemplary embodiment of the invention.

The display apparatus 700 shown in FIG. 5 is substantially the same as the display apparatus 100 illustrated in FIG. 1 except for a timing controlling part 750, the light source part 800 and a light source driving part 900. The same or like elements shown in FIG. 5 have been labeled with the same reference characters as used above to describe the exemplary embodiments of the display apparatus 100 shown in FIG. 1, and any repetitive detailed description thereof will hereinafter be omitted or simplified.

Referring to FIG. 5, an exemplary embodiment of the display apparatus 700 includes the display panel 110, the gate driving part 130, the data driving part 140, the timing controlling part 750, the light source part 800 and the light source driving part 900. The timing controlling part 750 and the light source driving part 900 may define a light source driving apparatus that drives the light source part 800.

The timing controlling part 750 receives the image data DATA and the control signal CON from the outside. The control signal CON may include the horizontal synchronous signal Hsync, the vertical synchronous signal Vsync and the clock signal CLK. The timing controlling part 750 generates the data start signal STH based on the horizontal synchronous signal Hsync and outputs the data start signal STH to the data driving part 140. In such an embodiment, the timing controlling part 750 generates the gate start signal STV based on the vertical synchronous signal Vsync and outputs the gate start signal STV to the gate driving part 130. In such an embodiment, the timing controlling part 750 generates the gate clock signal CLK1 and the data clock signal CLK2 based on the clock signal CLK, outputs the gate clock signal CLK1 to the gate driving part 130, and outputs the data clock signal CLK2 to the data driving part 140. In such an embodiment, the timing controlling part 750 may further output a light source control signal LSCS that controls a first light source 811 and a second light source 812, which are included in the light source part 850, to the light source driving part 900.

The light source part 800 provides light L to the display panel 110. The light source part 800 includes a light source group 810, and the light source group 810 includes the first light source 811 and the second light source 812.

The light source driving part 900 drives the first light source 811 and the second light source 812 based on the light source control signal LSCS provided from the timing controlling part 750.

In an exemplary embodiment, the light source driving part 900 includes a first light source driver 910 and a second light source driver 920. The first light source driver 910 outputs a first light source driving signal LD1 that drives the first light source 811 to the first light source 811. The second light source driver 920 outputs a second light source driving signal LD2 that drives the second light source 812 to the second light source 812.

Each of the first light source driving signal LD1 and the second light source driving signal LD2 includes n bit information or data. In one exemplary embodiment, for example, each of the first light source driving signal LD1 and the second light source driving signal LD2 may include 8 bit information or data. Each of the first light source driving signal LD1 and the second light source driving signal LD2 may be a pulse width modulation signal.

In an exemplary embodiment, the first light source driving signal LD1 and the second light source driving signal LD2 have different bit values. In such an embodiment, the first light source driving signal LD1 and the second light source driving signal LD2 have the different bit values and have a first bit average value during a first time period, and the first light source driving signal LD1 and the second light source driving signal LD2 have a second bit average value different from the first bit average value during a second time period different from the first time period. In such an embodiment, a difference of the bit values of the light source driving signal LD1 and the second light source driving signal LD2 is one (1).

In one exemplary embodiment, for example, the bit values of the first light source driving signal LD1 and the second light source driving signal LD2 may be as in the following Table 3.

TABLE 3

| | N − 1 | N |
|---|---|---|
| LD1 | 254 | 255 |
| LD2 | 255 | 255 |
| Bit average value | 254.5 | 255 |

In an exemplary embodiment, as shown in Table 3, the bit values of the first and second driving signals LD1 and LD2 may be 254 and 255, respectively, during an (N−1)-th time period. In such an embodiment, the bit average value of the first and second light source driving signals LD1 and LD2 during the (N−1)-th time period is 254.5 In an exemplary embodiment, the bit values of the first and second driving signals LD1 and LD2 may be 255 and 255, respectively, during an N-th time period. In such an embodiment, the bit average value of the first and second light source driving signals LD1 and LD2 during the N-th time period is 255.

The (N−1)-th time period may be a first time period, and the N-th time period may be a second time period. In an exemplary embodiment, the first bit average value is 254.5, the second bit average value is 255, and a difference between the first bit average value and the second bit average value is 0.5.

When the bit values of the first and second light source driving signals LD1 and LD2 are substantially the same as each other, a bit average value of the first and second light source driving signals LD1 and LD2 during the (N−1)-th time period and the N-th time period is changed with a minimum difference of 1. However, in an exemplary embodiment, the bit average value of the first and second light source driving signals LD1 and LD2 during the (N−1)-th time period and the N-th time period is changed with a minimum difference of 0.5. Thus, a luminance of the light L generated from the light source part 800 may be effectively controlled.

In an exemplary embodiment, the light source part 800 includes the first and second light sources 811 and 812, but it is not limited thereto. In an exemplary embodiment, as described above, the light source part 800 may include N (N is a natural number) light sources, and the light source driving part 900 may include N light source drivers that output N light source driving signals to the N light sources to drive the N light sources. In such an embodiment, the difference between the first bit average value and the second bit average value may be 1/N, and a bit average value may be changed with a minimum difference of 1/N.

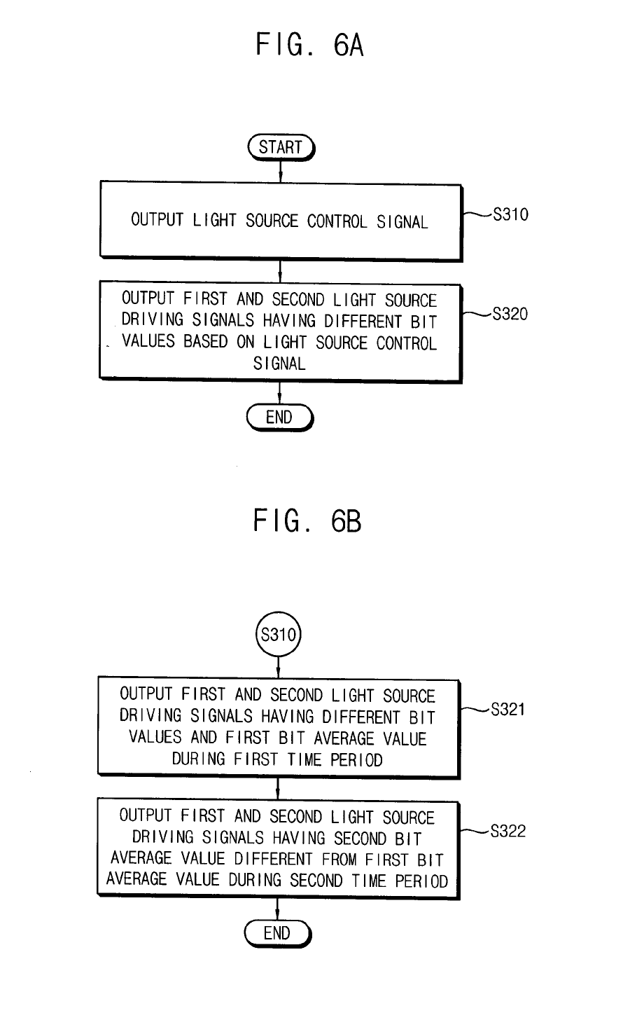

FIGS. 6A and 6B are flow charts illustrating an exemplary embodiment of a method of driving a light source performed by the light source driving apparatus of FIG. 5.

Referring to FIGS. 5 to 6B, the light source control signal LSCS is outputted (S310). In an exemplary embodiment, the timing controlling part 750 outputs the light source control signal LSCS driving the first light source 811 and the second light source 812 included in the light source part 800 to the light source driving part 900.

The first and second light source driving signals LD1 and LD2 having the different bit values are outputted based on the light source control signal LSCS (S320).

In an exemplary embodiment, the first and second light source driving signals LD1 and LD2 having the different bit values and having the first bit average value are outputted during the first time period (S321). The light source driving part 900 includes the first light source driver 910 and the second light source driver 920. The first light source driver 910 outputs the first light source driving signal LD1 driving the first light source 811 to the first light source 811. The second light source driver 920 outputs the second light source signal LD2 driving the second light source 812 to the second light source 812. In one exemplary embodiment, for example, the bit values of the first and second light source driving signals LD1 and LD2 may be 254 and 255, respectively, during the (N−1)-th time period. In such an embodiment, the bit average value of the first and second light source driving signals LD1 and LD2 is 254.5.

The first and second light source driving signals LD1 and LD2 having the second bit average value different from the first bit average value are outputted during the second time period (S322). In one exemplary embodiment, for example, the bit values of the first and second light source driving signals LD1 and LD2 may be 255 and 255, respectively, during the N-th time period. In such an embodiment, the bit average value of the first and second light source driving signals LD1 and LD2 is 255.

According to an exemplary embodiment, the bit average value of the first and second light source driving signals LD1 and LD2 is changed with a minimum difference of 0.5. Thus, the luminance of the light L generated from the light source part 800 may be minutely controlled.

According to exemplary embodiments of the method of driving a light source, the light source driving apparatus for performing the method and the display apparatus having the light source driving apparatus, light provided from a light source part to a display panel may be minutely controlled. Thus, display quality of the display apparatus may be improved.

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A method of driving a light source, the method comprising:
outputting a light source control signal which controls a plurality of light sources; and
outputting a plurality of light source driving signals to the light sources, respectively, based on the light source control signal, wherein the light source driving signals have different bit values.

2. The method of claim 1, wherein
the light source driving signals having the different bit values have a first bit average value during a first time period, and
the light source driving signals have a second bit average value different from the first bit average value during a second time period different from the first time period.

3. The method of claim 2, wherein
the light sources comprises first to fourth light sources,
the light source driving signals comprises first to fourth light source driving signals which drive the first to fourth light sources, respectively, and
the first to fourth light source driving signals have the different bit values during the first time period.

4. The method of claim 3, wherein a difference between the different bit values is 1.

5. The method of claim 4, wherein a minimum difference between the first bit average value and the second bit average value is 0.25.

6. The method of claim 2, wherein
the light sources comprises first to eighth light sources,
the light source driving signals comprises first to eighth light source driving signals which drives the first to eighth light sources, respectively, and
the first to eighth light source driving signals have the different bit values during the first time period.

7. The method of claim 6, wherein a difference between the different bit values is 1.

8. The method of claim 7, wherein a minimum difference between the first bit average value and the second bit average value is 0.125.

9. The method of claim 2, wherein
the light sources comprises first and second light sources,
the light source driving signals comprises first and second light source driving signals which drive the first and second light sources, respectively, and
the first and second light source driving signals have the different bit values during the first time period.

10. The method of claim 9, wherein a difference between the different bit values is 1.

11. The method of claim 10, wherein a minimum difference between the first bit average value and the second bit average value is 0.5.

12. The method of claim 2, wherein
the number of the light sources is N, which is a natural number,
a difference between the different bit values is 1, and
a minimum difference between the first bit average value and the second bit average value is 1/N.

13. A light source driving apparatus comprising:
a timing controlling part configured to output a light source control signal which controls a plurality of light sources; and
a light source driving part configured to output a plurality of light source driving signals to the light sources, respectively, based on the light source control signal, wherein the light source driving signals have different bit values.

14. The light source driving apparatus of claim 13, wherein
the light source driving signals having the different bit values have a first bit average value during a first time period, and
the light source driving signals have a second bit average value different from the first bit average value during a second time period different from the first time period.

15. The light source driving apparatus of claim 14, wherein
the light sources comprises first to fourth light sources,
the light source driving signals comprises first to fourth light source driving signals which drive the first to fourth light sources, respectively,
the first to fourth light source driving signals have the different bit values during the first time period,
a difference between the different bit values is 1, and
a minimum difference between the first bit average value and the second bit average value is 0.25.

16. The light source driving apparatus of claim 14, wherein
the light sources comprises first to eighth light sources,
the light source driving signals comprises first to eighth light source driving signals which drive the first to eighth light sources, respectively,
the first to eighth light source driving signals have the different bit values during the first time period,
a difference between the different bit values is 1, and
a minimum difference between the first bit average value and the second bit average value is 0.125.

17. The light source driving apparatus of claim 14, wherein
the light sources comprises first and second light sources,
the light source driving signals comprises first and second light source driving signals which drive the first and second light sources, respectively,
the first and second light source driving signals have the different bit values during the first time period,
a difference between the different bit values is 1, and
a minimum difference between the first bit average value and the second bit average value is 0.5.

18. The method of claim 14, wherein
the number of the light sources is N, which is a natural number,
a difference between the different bit values is 1, and
a minimum difference between the first bit average value and the second bit average value is 1/N.

19. A display apparatus comprising:
a display panel comprising a gate line and a data line, and configured to display an image;
a gate driving part configured to output a gate signal to the gate line;
a data driving part configured to output a data signal to the data line;
a light source part configured to provide light to the display panel, and comprising a plurality of light sources; and
a light source driving apparatus comprising:
a timing controlling part configured to output a gate control signal which controls the gate driving part, a data control signal which controls the data driving part, and a light source control signal which controls the light sources; and
a light source driving part configured to output a plurality of light source driving signals to the light sources, respectively, based on the light source control signal,
wherein the light source driving signals have different bit values.

20. The display apparatus of claim 19, wherein
the light source driving signals having the different bit values have a first bit average value during a first time period, and
the light source driving signals have a second bit average value different from the first bit average value during a second time period different from the first time period.
